(19) United States
(12) Patent Application Publication
(10) Pub. No.: US 2003/0053099 A1
(43) Pub. Date: Mar. 20, 2003

(54) Image reader for efficiently and properly operating a scanner and an image processing unit

(75) Inventor: Yasunobu Sakaguchi, Kanagawa (JP)

Correspondence Address: SUGHRUE MION, PLLC, 2100 Pennsylvania Avenue, N.W., Washington, DC, 20037, US

(73) Assignee: FUJI PHOTO FILM CO., LTD.

(21) Appl. No.: 10/244,397

(22) Filed: Sep. 17, 2002

(30) Foreign Application Priority Data
Sep. 18, 2001 (JP) 2001-283839
Jul. 31, 2002 (JP) 2002-223760

(51) Int. Cl. H04N 1/04; H04N 1/409; H04N 1/58; H04N 1/60; H04N 1/407; G06T 5/00; B41B 1/00

(52) U.S. Cl. 358/1.9; 358/3.24; 358/1.13; 358/527; 358/506; 358/3.27; 358/520; 358/521

(57) ABSTRACT

An image is read from a photo film by a scanner. Data of the read image is transferred to an image processing unit to process the image. When reading and processing the image, setting items are changed in accordance with a mode. In a high-image-quality mode, is executed at least one of the items including increment of a read pixel number, improvement of an SN ratio, correcting processes, reduction of an electronic magnification, and monitoring. In a high-speed mode, is executed at lease one of the items including reduction of the read pixel number, omission of the correcting processes, increment of the electronic magnification, omission of monitoring, and omission or reduction of automatic focusing. The mode is selected so as to meet an operational purpose so that the image is efficiently read.

### BACKGROUND OF THE INVENTION

1. Field of the Invention

The present invention pertains to a technical field of digital image processing and relates to an image reader, which is capable of operating a scanner and an image processing unit efficiently and properly in accordance with an operational purpose when producing a print and so forth.

2. Description of the Related Art

A printer utilizing a digital exposure, namely a digital photo printer appears on the market. In the digital photo printer, an image recorded on a film is photoelectrically read and the read image is converted into a digital signal. After that, various kinds of image processing are executed to produce image data used for recording. In accordance with the image data, a recording light is modulated. A photosensitive material is scanned and exposed with the modulated recording light to record an image (latent image) thereon. In this way, a print is made.

Basically, the digital photo printer includes a scanner, an image processor, a print section, and a print processor. The scanner photoelectrically reads the image recorded on the film, by reading a projection light of a read light irradiated to the film. The image processor executes predetermined processes for the image data, which is read by the scanner or is supplied from a digital camera and so forth, to produce image data, namely to set exposure conditions, used for recording the image. The print section records a latent image by scanning the photosensitive material with a light beam or the like in accordance with the image data outputted from the image processor. The print processor executes a developing process for the photosensitive material exposed by the print section to make a finish print on which the image is reproduced.

According to this kind of the digital printer, the image is converted into digital image data so that it is possible to process (correct) the image by processing the image data. Thus, processes including gradation adjustment, color-balance adjustment, color adjustment, density adjustment, and sharpness are properly executed so that a high-quality print may be obtained. Further, according to the digital photo printer, besides the image photographed on the film, it is possible to output, as a print, an image photographed by a digital camera or the like. It is also possible to output, as a print, image data recorded in a recording medium of MO (Magneto Optical Disk) and so forth, and image data obtained through a communication channel of the Internet and so forth.

By the way, performance required for the digital photo printer is different in accordance with a usage condition of a printing shop including a laboratory shop and so forth, where the print is produced. For example, the printing shop exclusively producing the print at low price is likely to regard productivity as important, although quality of a printed image is slightly deteriorated. In contrast, the other printing shops usually producing a print of a photograph taken in a photo studio and usually receiving a special order are likely to regard the quality of the printed image as important, although the productivity is slightly sacrificed. On the other hand, a customer (requesting a print) sometimes desires the low price at the sacrifice of the image quality, and sometimes desires the high image quality even if the cost increases.

However, such requirements are contrary to each other in a sensed. When one performance is raised, the other performance is usually lowered. For instance, when the image is conscientiously processed with great accuracy, the high-quality image may be obtained, but the productivity is lowered more for that. When the productivity is regarded as important, it is preferable to prevent the image from being conscientiously processed so that the image quality is deteriorated. In light of this, the performance of the conventional photo printer is set so as to evenly fulfill required characteristics of the image quality, the productivity and so forth. However, when the required characteristics are evenly fulfilled, sometimes the printing shop and the customer do not satisfy the performance of the apparatus.

In view of this, the present assignee suggests an image processing unit comprising a condition setting section and an image processor (for instance, in Japanese Patent Laid-Open Publication No. 2001-218047). The condition setting section analyzes image data to set image processing conditions. The image processor executes image processing in accordance with the image processing conditions set by the condition setting section. The image processing unit is provided with operation modes respectively corresponding to an operational purpose. The image processing unit includes a switching member for changing at least one of the processing in the condition setting section and the image processing in the image processor, in accordance with the operation mode. The image processing unit further includes a selection member for selecting the operation mode. In this image processing unit, however, the operation mode is changed, putting a stress on the image processing conditions. Thus, an operation of a scanner side is not fully considered, and there arises a problem in that it is impossible to further improve the image quality and to further fasten an image processing speed.

### SUMMARY OF THE INVENTION

In view of the foregoing, it is a primary object of the present invention to provide an image reader, which is capable of properly fulfilling various requirements of performance relative to a photo printer, namely properly fulfilling productivity, an image quality and so forth.

It is a second object of the present invention to provide an image reader, which is capable of properly producing a print along a usage condition of a photo printer used in a printing shop.

It is a third object of the present invention to provide an image reader, which is capable of properly producing a print along intentions of a customer and a printing shop.

In order to achieve the above and other objects, the image reader according to the present invention comprises an image reading member, an image processing member, a mode setting member, and a selection member. The image reading member reads image data from an image original on the basis of an image read condition. The image processing member executes image processing for the image data on the basis of an image processing condition. The mode setting member is provided with operation modes including at least a high-image-quality mode and a high-speed mode. The mode setting member changes the image read condition and the image processing condition, which are individually set to the respective operation modes, in accordance with the operation mode. The selection mode selects the operation mode on the basis of a size of the image original and an image output size.

Under the high-image-quality mode, the image read condition and the image processing condition are set so as to obtain high image quality by changing at least one of setting conditions including a pixel read number, a read output level, a correcting process, image display performed after the correcting process, and an examination performed after the correcting process.

Under the high-speed mode, the image read condition and the image processing condition are set so as to execute processing at high speed by changing at least one of the setting conditions including the pixel read number, the read output level, the correcting process, the image display performed after the correcting process, and the examination performed after the correcting process.

According to the present invention, the image read condition and the image processing condition are changed in accordance with the operation mode so that not only the condition of the image processing member but also the condition of the image reading member is changed. Thus, processing may be efficiently executed so as to meet various purposes of an image-quality prioritizing process, a processing-speed prioritizing process, and so forth.

### BRIEF DESCRIPTION OF THE DRAWINGS

The above objects and advantages of the present invention will become apparent from the following detailed description of the preferred embodiments of the invention when read in conjunction with the accompanying drawings, in which:

FIG. 1 is a block diagram showing a digital photo printer according to the present invention;

FIG. 2 is a block diagram showing an image processing unit of the digital photo printer;

FIG. 3 is a block diagram showing a main-scan processor of the image processing unit;

FIG. 4 is an explanatory illustration showing items for alteration of setting relative to each portion under certain operation modes;

FIG. 5 is a block diagram showing a digital photo printer according to another embodiment;

FIG. 6 is an explanatory illustration showing a mode setting table in which a high-image-quality setting condition is designated;

FIG. 7 is an explanatory illustration showing a mode setting table in which a high-speed-processing setting condition is partially designated;

FIG. 8 is a flowchart showing a mode changing process; and

FIG. 9 is a flowchart showing other embodiment in which a setting condition is selected by using the mode setting table.

### DETAILED DESCRIPTION OF THE PREFERRED EMBODIMENT(S)

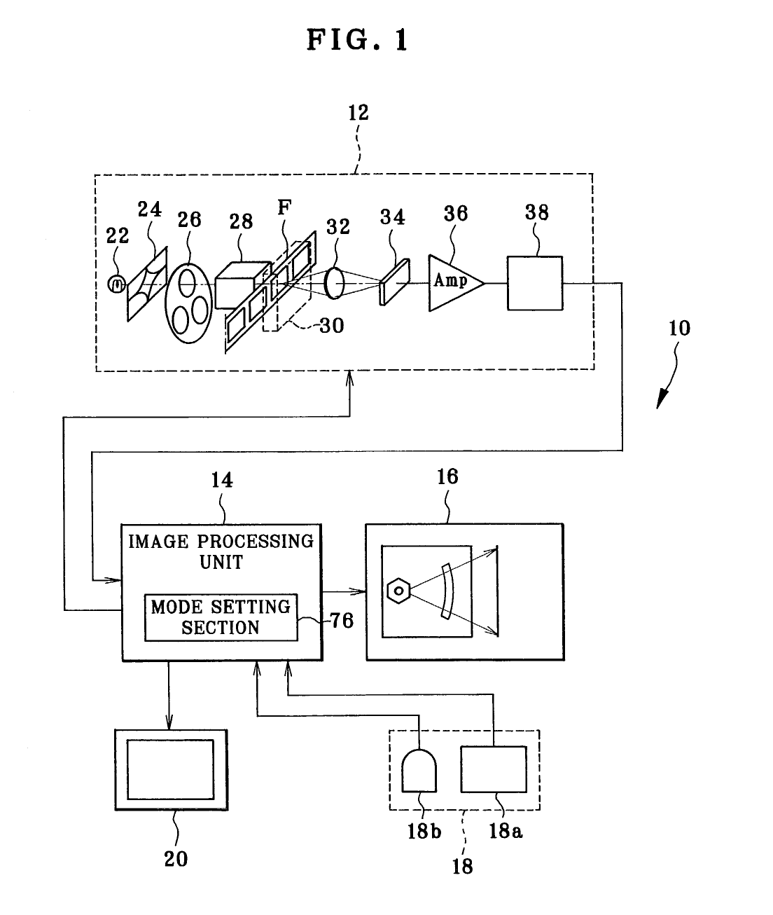

FIG. 1 is a block diagram showing a digital photo printer using an image reader according to the present invention. The digital photo printer (hereinafter, simply called as photo printer 10) is basically constituted of a scanner 12, an image processing unit 14, and a printer processor 16. The image processing unit 14 is connected to an operation system 18 and a display 20. The operation system 18 includes a keyboard 18a and a mouse 18b in order to input various setting conditions, a selection and an instruction of processing, instructions of color correction and density correction, and so forth. The display 20 shows a simulation picture and so forth used for examination.

The scanner 12 photoelectrically reads an image taken on a photo film F and so forth one frame by one frame. The scanner 12 is constituted of a white light source 22, a variable stop 24, a color filter plate 26, a diffusion box 28, a carrier 30, an image-forming lens unit 32, an area CCD sensor 34 (hereinafter, called as CCD sensor), an amplifier 36, an A-D (analog-to-digital) converter 38. The diffusion box 28 uniformly diffuses a read light, which radiates to the film F, in a surface direction of the film F.

When the scanner 12 reads the image taken on the film F, the read light radiates from the light source 22 first. The read light, whose amount is adjusted by the variable stop 24, enters the color filter plate 26 for light regulation. Successively, the read light is diffused by the diffusion box 28. After that, the read light enters one frame of the film F held by the carrier 30 at a predetermined read position. The read light passes through the frame to apply a projection light carrying the image of the film F. The projection light forms the image on a light-receiving surface of the CCD sensor 34 by means of the image-forming lens unit 32. In this way, the image of the film F is photoelectrically read. An output signal of the CCD sensor 34 is amplified by the amplifier 36 and is converted into a digital signal by the A-D converter 38. The digital signal is sent to the image processing unit 14.

The color filter plate 26 is a turret having color filters of R(red), G(green) and B(blue). The color filter plate 26 is rotated by a rotary member, which is not shown, to place the respective color filters at an optical path of the read light. In the scanner 12 of this embodiment, the respective color filters of the color filter plate 26 are placed at the optical path in turn to read the image three times. Owing to this, the image on the film F is read so as to be resolved into three primary colors of R, G and B. By the way, a large number of light emitting diodes (LEDs) of R, G and B arranged in matrix may be used instead of using the white light source 22, the variable stop 24 and the color filter plate 26. In this case, the light emitting diode of IR used for erasing a scratch may be included when the need arises.

The carrier 30 is detachably attached to a body of the scanner 12. The exclusive carrier 30 corresponding to each film type of IX240-type, 135-type and so forth is prepared for the scanner 12. The corresponding carrier 30 is properly changed and is attached in accordance with a film size and so forth. By means of the carrier 30, the image (frame) taken on the film and used for producing a print is conveyed to and kept in a predetermined read position.

The 135-type carrier 30 is provided with a read member for reading a bar code of DX code, expanded DX code, FNS code and so forth. The IX240-type carrier 30 is provided with a read/write member for magnetic information. The read/write member is disposed so as to confront a magnetic recording medium formed on the film F. The bar code and the magnetic recording medium are read while the carrier 30 conveys the film F. The various information read from the bar code and the magnetic recording medium are transferred to the image processing unit 14, the printer processor 16 and so forth.

A way of reading the image of the film F is not exclusive to the above way. It is possible to use a scanner performing slit scanning with a line CCD sensor of three colors. Further, the photo printer 10 may produce a print by using a reflection-original-type scanner instead of the scanner reading the film photoelectrically.

When the scanner 12 reads the image taken on the film F, scanning are performed two times, one of which is pre-scanning for reading the image at low resolution, and the other of which is main scanning for obtaining image data used for an output of the print. The pre-scanning is performed under a pre-scan read condition predetermined such that the whole of the film image to be scanned by the scanner 12 is read without saturating the CCD sensor 34. Meanwhile, the main scanning is performed under a main-scan read condition, which is set for each frame from pre-scan data, so as to saturate the CCD sensor 34 at a certain density which is slightly lower than the minimum density of the present image (frame). Thus, output signals of the pre-scanning and the main scanning are identical except the resolution and an output level.

On the basis of the pre-scan data, a finish image is simulated on the display 20. Incidentally, as described later, a mode setting section 76 sets image reading conditions in accordance with a high-image-quality mode and a high-speed mode. The image reading conditions includes an optical magnification for reading, a number of image shifting, a read number in an averaging process relative to reading to be performed plural times, setting of automatic focusing, setting of simulate display, size change of the simulate display, setting of an examining operation, and so forth.

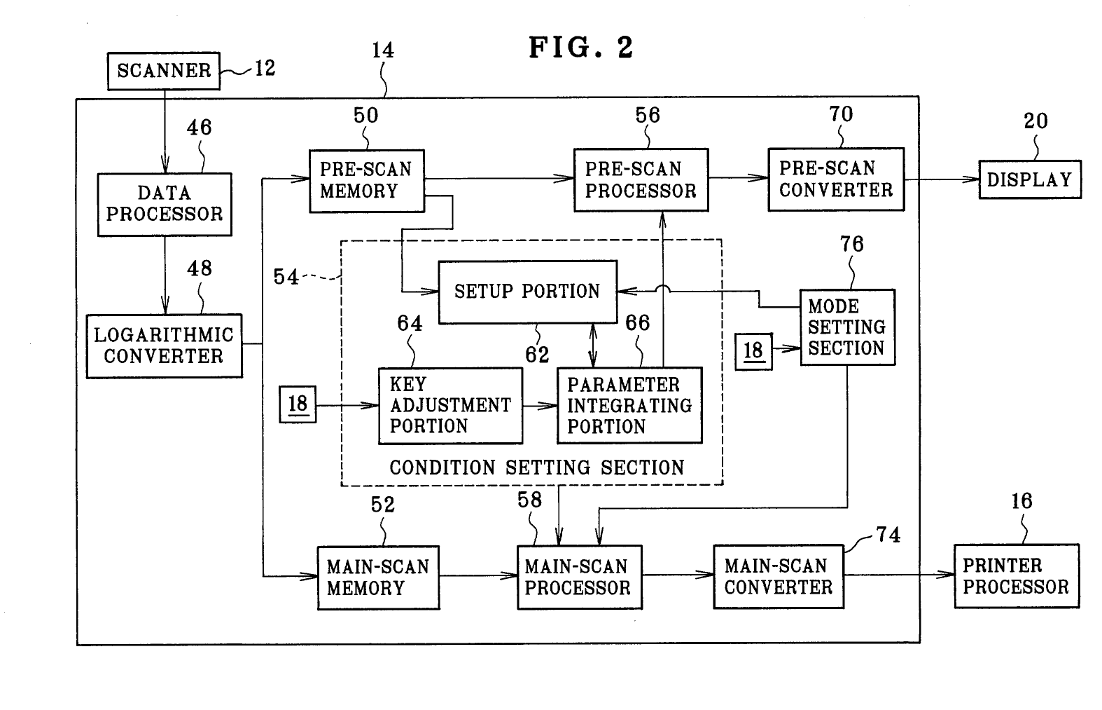

The output signal (image data) from the scanner 12 is outputted to the image processing unit 14. As shown in FIG. 2, the image processing unit 14 (hereinafter, called as processing unit 14) is constituted of a data processor 46, a logarithmic converter 48, a pre-scan memory 50, a main-scan memory 52, a condition setting section 54, a pre-scan processor 56, a main-scan processor 58, a pre-scan converter 70, a main-scan converter 74, and the, mode setting section 76. Although FIG. 2 mainly shows the components concerning image processing, the processing unit 14 controls and manages the whole photo printer 10 so that other components are provided in addition to the components shown in FIG. 2. The other components includes a CPU for controlling the whole of the photo printer, a memory which stores information necessary for operating the photo printer 10, and so forth.

In the data processor 46, predetermined processes of DC offset correction, dark correction, shading correction and so forth are executed for the output data of R, G and B outputted from the scanner 12. Successively, the output data processed in the data processor 46 is logarithmically converted in the logarithmic converter 48 by using an LUT (Look Up Table) and so forth to produce digital image (density) data. The pre-scan (image) data is stored in the pre-scan memory 50, and the main-scan (image) data is stored in the main-scan memory 52.

The condition setting section 54 determines image processing conditions of the respective images to be set in the pre-scan processor 56 and the main-scan processor 58. The condition setting section 54 includes a setup portion 62, a key adjustment portion 64, and a parameter integrating portion 66.

The setup portion 62 sets the image processing condition of each frame on the basis of image analysis carried out by using the pre-scan data. Concretely, the setup portion 62 draws up a density histogram of the image and calculates image-characteristic values of the minimum density, the maximum density, the average density and so forth, by using the pre-scan data. Moreover, the setup portion 62 extracts a main subject (face area). Further, the setup portion 62 sets the read condition of the main scanning by using the density histogram, the image-characteristic values and so forth. Furthermore, the setup portion 62 determines the image processing conditions to be set in the pre-scan processor 56 and the main-scan processor 58, such as described later. These sorts of operations, namely the image analysis and the setting of the image processing conditions may be carried out by a well-known method. Incidentally, the operation is switched by the mode setting section 76 in accordance with the selected operation mode. With respect to this point, a detail thereof is described later.

The key adjustment portion 64 calculates an adjustment amount of the image in accordance with adjustment instructions and so forth inputted with adjustment keys and the mouse 18b. The adjustment keys are provided on the keyboard 18a and include a density adjustment key, a color adjustment key, a gradation adjustment key, a sharpness adjustment key and so forth. The calculated adjustment amount is supplied to the parameter integrating portion 66. This parameter integrating portion 66 receives the image processing condition determined by the setup portion 62. The image processing condition is located at a predetermined position of the pre-scan processor 56 and the main-scan processor 58. The parameter integrating portion 66 further executes adjustment (correction) of the image processing condition, which is already set to each position, in accordance with the adjustment amount of the image calculated by the key adjustment portion 64. Besides adjusting the image processing condition, the parameter integrating portion 66 makes up a process condition for performing the adjustment of the image processing condition, and carries out setting to both processors.

In the processing unit 14, image processing is executed such that the pre-scan data stored in the pre-scan memory 50 is processed in the pre-scan processor 56 and the main-scan data stored in the main-scan memory 52 is processed in the main-scan processor 58. The pre-scan processor 56 and the main-scan processor 58 basically have a similar structure and execute similar processing except that pixel density of the image data to be processed is different. Thereupon, the main-scan processor 58 is described as representative in the following.

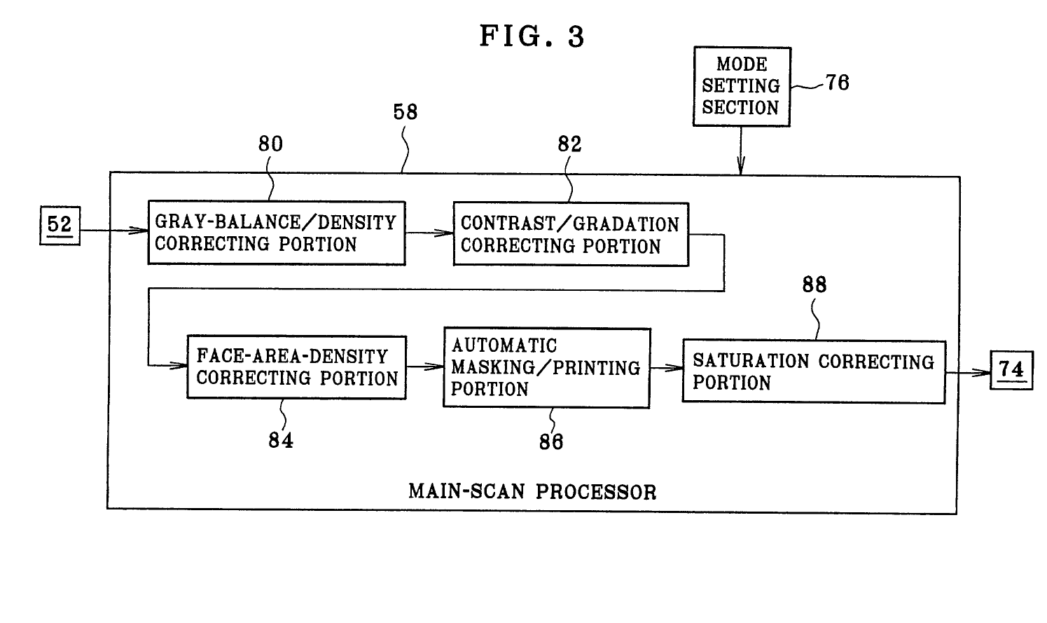

The main-scan processor 58 reads the main-scan data stored in the main-scan memory 52 to execute various kinds of image processing. Similarly, the pre-scan processor 56 reads the pre-scan data stored in the pre-scan memory 50 to execute various kinds of image processing. As shown in FIG. 3, the main-scan processor 58 includes a gray-balance/density correcting portion 80, a contrast/gradation correcting portion 82, a face-area-density correcting portion 84, an automatic masking/printing portion 86, and a saturation correcting portion 88. The pre-scan processor 56 is similarly constituted. Incidentally, it is needless to say that the image processing unit according to the present invention may include other processors for executing other kinds of processing except the above processing. For instance, the other processors are an electronic magnification processor and a sharpness emphasizing processor for emphasizing an edge of the image and sharpening the image.

The gray-balance/density correcting portion 80 executes the gray-balance correction (color-balance correction) of the image and the density correction of the respective colors (R, G and B) thereof by using the LUT, for instance. The contrast/gradation correcting portion 82 executes the contrast correction of the image and the gradation correction thereof by similarly using the LUT. The face-area-density correcting portion 84 adjusts the density of the face area in accordance with an extraction result of the face so as to finish the person's face in a appropriate flesh color.

The automatic masking/printing portion 86 has an effect similar to a masking/printing process of a direct exposure. Concretely, a dynamic range (difference between the maximum density and the minimum density) of the original image is compressed linearly or non-linearly to compress the gradation. By compressing the gradation, a dynamic range of an output image is adjusted to a density reproductionable range (print reproduction range) of an output apparatus (the printer processor 16 shown in the drawings). Such processing is executed in the automatic masking/printing processor 86. The masking/printing process is described in Japanese Patent Laid-Open Publication 10-13680 filed by the present assignee. Meanwhile, the saturation correcting portion 88 executes saturation correction (saturation control) of the image by means of a matrix operation and so forth. The electronic magnification processor executes scaling of the image in accordance with a print size and so forth.

The processing unit 14 shown in the drawing has the mode setting section 76, in which three operation modes of the high-image-quality mode, the high-speed mode and a normal mode are set. The mode setting section 76 changes the image reading condition of the scanner in accordance with the selected operation mode. Besides this, the mode setting section 76 changes the processes of the setup portion 62. In other words, the mode setting section 76 changes the setting of the image analysis and the image processing condition, and the image processing executed in the main-scan processor 58 (the pre-scan processor 56). Owing to this, the image processing is executed for the main-scan data (pre-scan data) in accordance with the selected operation mode.

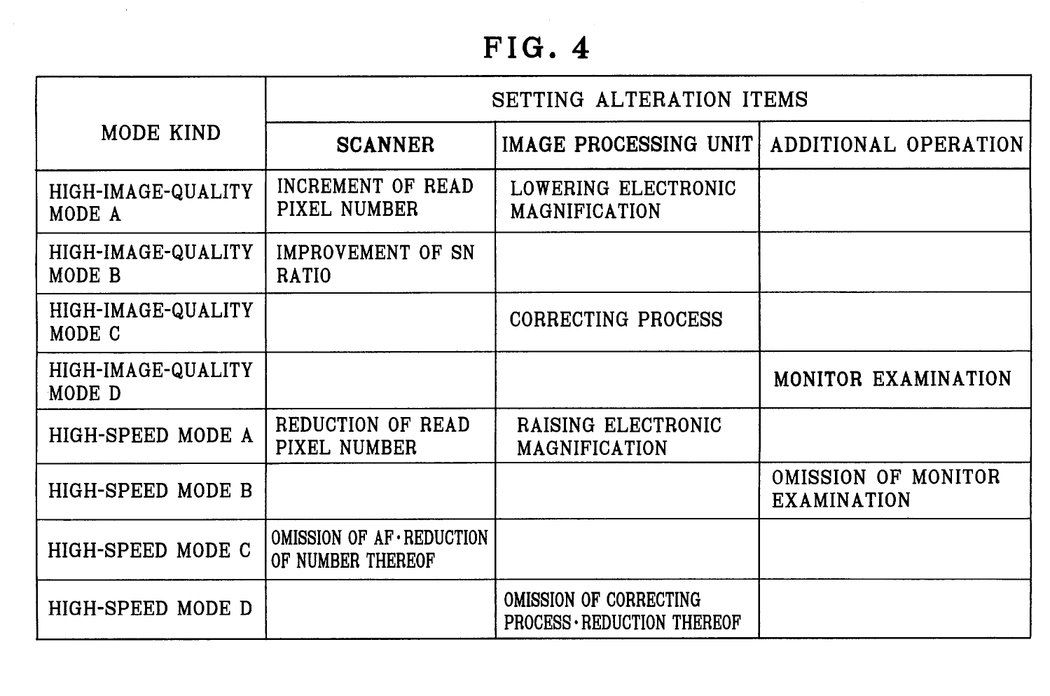

As shown in FIG. 4, in the present embodiment, four kinds of modes A to D are prepared as the high-image-quality mode. Moreover, four kinds of modes A to D are prepared as the high-speed mode.

The high-image-quality mode is an operation mode in which a photographic quality (quality of the image reproduced as a print) is regarded as important. This operation mode suits a case in that a lot of high magnification prints are required and a lot of special orders are requested. Under the high-image-quality mode A, the high image quality is obtained in the scanner 12 by carrying out an operation for increasing a read pixel number. As to this operation for increasing the read pixel number, it is supposed to raise an optical magnification and to increase a pixel shifting number. Further, the high image quality is obtained in the image processing unit 14 by carrying out an operation for lowering an electronic magnification. This operation for lowering the electronic magnification may be executed together with setting of the high optical magnification and increment of the pixel shifting number.

Under the high-image-quality mode B, the high image quality is obtained in the scanner 12 by carrying out a reading operation in a state that an SN-ratio is improved. As to an operation for improving the SN ratio, it is supposed to alter a storage charge amount. Incidentally, the operation for altering the storage charge amount may be solely executed, but may be executed together with the operation for lowering the electronic magnification.

Under the high-image-quality mode C, is executed at least one of the gray/color gradation control (gray-balance correction, gradation correction and density correction) in the gray-balance/density correcting portion 80 and the contrast/gradation correcting portion 82, the correction in the face-area-density correcting portion 84, the correction in the automatic masking/printing portion 86, and the correction in the saturation correcting portion 88. Incidentally, the gray/color gradation control is executed in accordance with at least one of scene information, exposure information and film sorts (trade name, grade, sensitivity and so forth). It is preferable to execute the gray/color gradation control at least in accordance with the scene information. In this way, the optimum image processing is executed for the subject image (photographic scene) to obtain a high-quality image.

In the present embodiment, when the high-image-quality mode C is selected, the mode setting section 76 changes the image analysis and the image processing condition, which are set by the setup portion 62, and image processing to be executed in the main-scan processor 58 so as to execute the gray/color gradation control in accordance with the scene information and so forth, and so as to execute the saturation correction and the automatic masking/printing process in accordance with a scene analysis result and so forth. Incidentally, in a case of the IX240-type, magnetic information may be used as the scene information and the exposure information. These information are optically recorded outside the image area of the film F and may be obtained by using the CCD sensor 34. Further, an operator may obtain the information from a customer. The information from the customer may be inputted with the keyboard 18a and so forth.

Under the high-image-quality mode D, the finish image is simulated on the display 20. An operator watches the simulated finish image to perform a monitor examination. Owing to this, a high-quality image is obtained.

The high-speed mode is an operation mode in which a print producing speed (for instance, an output number per unit time) is regarded as important. Under the high-speed mode A, the high speed is obtained in the scanner 12 by carrying out an operation for reducing the read pixel number. As to this operation for reducing the read pixel number, it is supposed to lower the optical magnification, and to reduce the pixel shifting number or to prohibit the shift of pixel. Further, the high speed is obtained in the image processing unit 14 by carrying out an operation for raising the electronic magnification. Incidentally, the operation for raising the electronic magnification may be solely executed, but may be executed together with the setting of the high optical magnification, reduction of the pixel shifting number and prohibition of pixel shifting.

Under the high-speed mode B, display of the examination image is omitted and inputs of the correction keys for the color and the density are also omitted so that a processing ability is more improved. Under the high-speed mode C, automatic focusing is performed only at the first of one order, and then, a result thereof is utilized until the order is changed. Thus, an autofocus operation is omitted so that the processing ability is improved. Incidentally, instead of performing the automatic focusing only for the first frame of one order, the automatic focusing may be omitted for all of the frames.

Under the high-speed mode D, the color correction and the density correction are omitted so that the processing ability is more improved. The processing ability may be improved by omitting special correction instead of omitting the color correction and the density correction. For example, the gray-balance correction and the density correction are merely executed without performing, for instance, the face-area-density correction and the automatic masking/printing process taking a lot of time. Further, the gradation correction may be additionally executed. In this case, the mode setting section 76 changes the image analysis and the image processing condition, which are set by the setup portion 62, and the image processing to be executed in the main-scan processor 58 so as to merely execute the three kinds of image processing. Owing to this, an outputting ability of the photo printer is maximally exercised to output a large number of prints in a short time.

The normal mode is an operation mode for producing a normal print. Under this operation mode, characteristics of the above-described modes are evenly called forth. The image processing condition is set and the image processing is executed so as to keep the image quality, the print productivity and so forth in a good-balance state.

A selection member for selecting the above operation modes is not exclusive. A switch or the like for changing the operation mode may be provided. The keyboard 18a may be provided with an extra key used for the operation mode (a function key may be utilized). Alternatively, the operation mode may be selected with GUI (Graphical User Interface) and so forth. Further, the operation mode may be selected by a manufacturer when shipped from a factory. The operation mode may be selected by a service engineer at a user's place in accordance with a request. Especially, it is preferable that the user is capable of optionally selecting the operation mode by an easy operation with the GUI and so forth.

As described above, the various operation modes are set in the processing unit 14. The operation mode is selected, and the image read condition of the scanner is changed by the mode setting section 76 in accordance with the selected operation mode. Moreover, are changed the image analysis and the image processing condition set by the setup portion 62. The image processing in the main-scan processor 58 (pre-scan processor 56) is also changed. Thus, according to the image processing unit of the present invention, it is possible to realize the photo printer fully satisfying the characteristics requested by the user. In this photo printer, the operation mode is selected along the usage condition of the photo printer set in the print shop and along the intention of the print producer so that it is possible to produce the print meeting a certain purpose.

The pre-scan data is transferred to the pre-scan converter 70 after the image processing has been executed for the pre-scan data in the pre-scan processor 56. The main-scan data is transferred to the main-scan converter 74 after the image processing has been executed for the main-scan data in the main-scan processor 58. The pre-scan converter 70 executes color-reproduction conversion for the pre-scan data to be reproduced on the display 20, by using a three-dimensional LUT (3D-LUT) for example. In other words, the pre-scan converter 70 converts the pre-scan data into image data corresponding to the color to be reproduced on the display 20. Meanwhile, the main-scan converter 74 similarly executes the color-reproduction conversion for the main-scan data to be recorded by the printer processor 16, by using a 3D-LUT. In other words, the main-scan converter 74 converts the main-scan data into image data corresponding to the color reproduced by the printer processor 16.

The pre-scan data is transferred to the display 20 after the color-reproduction conversion has been executed for the pre-scan data in the pre-scan converter 70. The main-scan data is transferred to the printer processor 16 after the color-reproduction conversion has been executed for the main-scan data in the main-scan converter 74. The display 20 is not exclusive. It is possible to use various kinds of well-known display units, for instance, a CRT (Cathode Ray Tube) and a liquid-crystal display.

The printer processor 16 records a back print after cutting a photosensitive material, for example, into a predetermined length corresponding to the print. Further, the printer processor 16 performs scanning exposure for the photosensitive material (photographic printing paper) to record a latent image. The scanning exposure is two-dimensionally performed with light beams of R-exposure, G-exposure and B-exposure, which are modulated in accordance with the main-scan data transferred from the processing unit 14 (main-scan converter 74). Successively, predetermined wet developing processes of color development, bleach-fix, washing and so forth are carried out for the photosensitive material. After drying the photosensitive material to be finished as a print, the photosensitive materials are sorted and stacked.

Incidentally, as to the correction processes, the image reader of the present invention may be provided with a high-image-quality mode for executing marginal-luminosity correction, distortion correction and so forth, in addition to the above-described correction. Purposes for providing this high-image-quality mode is that high-quality prints (images) are stably outputted relative to a photo film exposed by a compact camera and a lens-fitted photo film unit employing a low-cost lens.

Next, an embodiment, in which image-quality conversion is set by managing a pixel number, is described below. In this embodiment, a full-size frame of the 135-type is printed out as a king (KG) size of 102×152 mm. For example, when an output apparatus to be used has an output pixel density of 300 dpi (dot per inch), the pixel number required for an output is as follows.

(V) 102×300÷25.4=1205

(H) 152×300÷25.4=1795

When a normal print magnification (enlargement ratio of a print size to an original size) is 4.5 times, the original size changed over to the print is as follows.

(V) 102÷4.5=22.67

(H) 152÷4.5=33.78

An imaging device is an area CCD having a pixel pitch of 10×10 μm and a total pixel number of 2000×3000.

A print magnification MP is obtained by the following formula when an optical read magnification is represented as MO, an electronic magnification is represented as ME, and a pixel-density conversion magnification is represented as γ.

MP=MO×ME×γ

The pixel-density conversion magnification γ means a ratio of the pixel density (300 dpi) of the output apparatus to the pixel density (10 μm) of the imaging device (CCD), and is obtained such as follows.

γ=(25.4÷300)÷0.01=8.47

It is possible to change the image quality of the printout by fixing the print magnification and changing the other conditions, since the high image quality is obtained, in general, as the electronic magnification becomes lower. For example, when the optical read magnification MO is low and the electronic magnification ME is high, the read pixel number is reduced. In this case, although the image quality of the print is lowered, the image processing for electrically varying the magnification has a little load. Thus, it becomes possible to execute the processing at high speed. In contrast, when the optical read magnification MO is high and the electronic magnification ME is low, the printout of high image quality is obtained. However, it takes a long processing time for electrically varying the magnification, and large memory capacity is required for processing. On the basis of the above theory, are described below the normal mode, the high-image-quality mode and the high-speed mode.

[Normal Mode]

When the optical read magnification MO is 0.6 times in main scanning, a region of the original projected to the CCD is as follows.

(V) 22.67×0.6=13.602(mm)

(H) 33.78×0.6=20.268(mm)

A CCD pixel number existing in this state, namely the read pixel number is as follows.

(V) 13.602÷0.01=1360

(H) 20.268÷0.01=2026

The electronic magnification ME is obtained from a ratio of the read pixel number to the output pixel number, and is as follows.

(V) 1205÷1360×100=88.6(%)

(H) 1795÷2026×100=88.6(%)

[High-Image-Quality Mode]

In order to set the read condition in which the image quality is regarded as important, the read pixel number is increased. In other words, the optical read magnification MO is raised. When the optical read magnification MO is 0.85 times, a size projected to the CCD is as follows.

(V) 22.67×0.85=19.270(mm)

(H) 33.78×0.85=28.713(mm)

The read pixel number is as follows.

(V) 19.270÷0.01=1927

(H) 28.713÷0.01=2871

The electronic magnification ME is as follows.

(V) 1205÷1927×100=62.5(%)

(H) 1795÷2871×100=62.5(%)

The electronic magnification ME becomes lower in comparison with the case of the normal mode so that the printout has high image quality.

[High-Speed Mode]

By contrast, in order to execute the processing at high speed, an amount of the processing data is reduced. For reducing the read pixel number, the optical read magnification MO is lowered. For example, when the optical read magnification MO is 0.45 times, a size projected to the CCD is as follows.

(V) 22.67×0.45=10.202(mm)

(H) 33.78×0.45=15.201(mm)

The read pixel number is as follows.

(V) 10.202÷0.01=1020

(H) 15.201÷0.01=1520

It becomes possible to execute the processing at high speed. Meanwhile, the electronic magnification ME is as follows.

(V) 1205÷1020×100=118.1(%)

(H) 1795÷1520×100=118.1(%)

The electronic magnification becomes higher in comparison with the case of the normal mode so that the image quality is deteriorated.

Next, another embodiment of the present invention is described below. This embodiment includes an input member for inputting a film size and a print size. The film size is an image original size and the print size is an image output size. On the basis of the film size and the print size inputted by the input member, the corresponding operation mode is automatically selected. Therefore, as shown in FIG. 5, a film carrier 101 comprises a film-size judgement member 100 to judge the film size set thereto. The film size may be specified from a film width, a frame size of an image recorded on the film, and so forth. The film carrier 101 usually has a film passage corresponding to the film size so that the film size is specified by detecting a width of the film passage.

When the print size is inputted as a print condition prior to printing, information thereof may be utilized. In a type wherein the print size is designated by an operator at each time, the designated information may be utilized. Meanwhile, the photo film of the IX240-type has a magnetic recording area for writing print designation information. As to this kind of the photo film in which the print designation information is recorded, the film carrier 101 reads this information to be used.

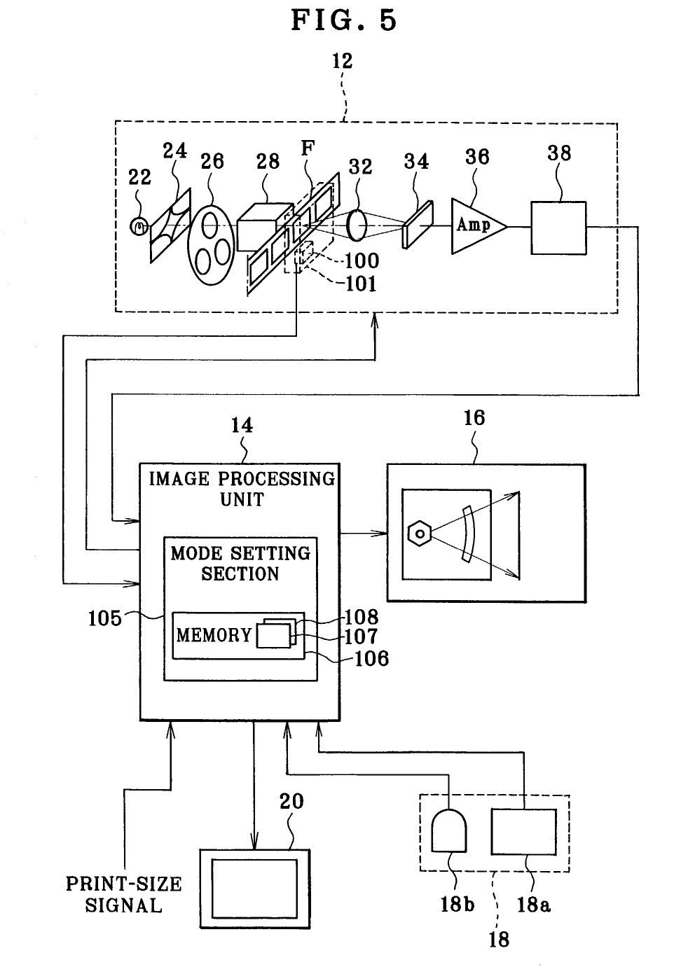

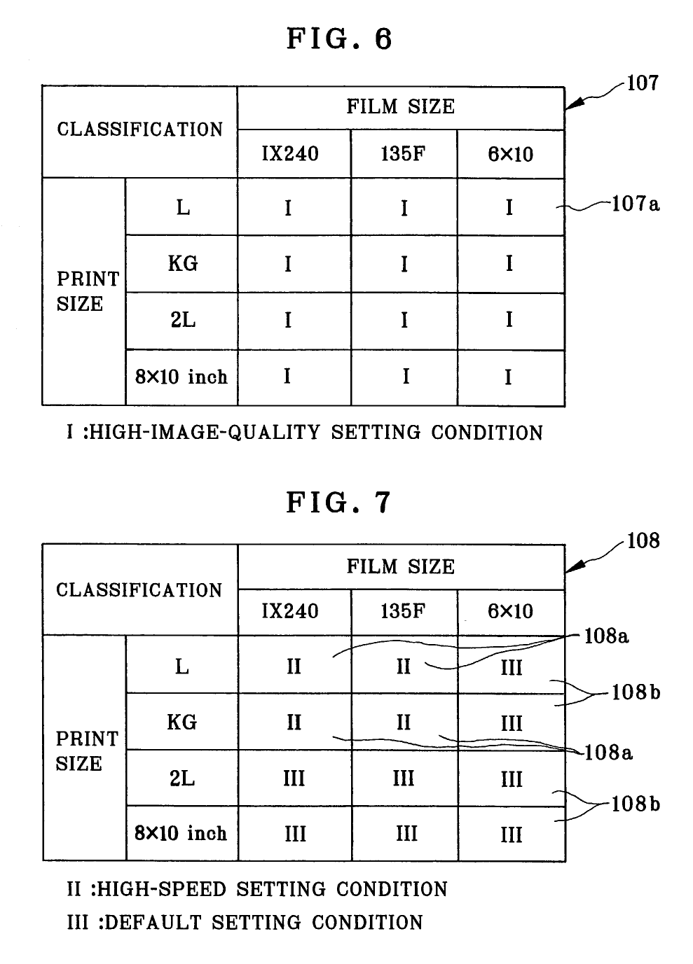

A mode setting section 105 comprises a memory 106 in which mode setting tables 107 and 108 described below are written. In a predetermined region of the mode setting tables 107 and 108, the corresponding setting mode is written. As shown in FIGS. 6 and 7, horizontally-arranged items of the mode setting tables 107 and 108 represent the film size, and vertically-arranged items thereof represent the print size. The film size includes three kinds of IX240, 135F (135 full-size) and 6×9, which are frequently used. The print size includes four kinds of L-size (89×127 mm (3R:3.5×5 inch)), KG-size (102×152 mm(4R:4×6 inch)), 2L-size (89×257 mm), 8×10 inch size (203×254 mm), which are frequently used. Each of the regions divided by the above items stores the corresponding operation mode.

FIG. 6 shows the mode setting table 107 wherein the high-image quality is regarded as important and a high-image-quality setting condition I is written in the respective regions 107a. FIG. 7 shows the mode setting section 108 wherein the high-speed processing is regarded as important and a high-speed-processing setting condition II is written in the regions 108a assigned by the IX240, the 135F, the L-size and the KG size. Except for the regions 108a, a default setting condition III of the apparatus is written in the regions 108b. Under the default setting condition III, various control factors are set on the basis of an intermediate condition between the high-image-quality setting condition I and the high-speed-processing setting condition II.

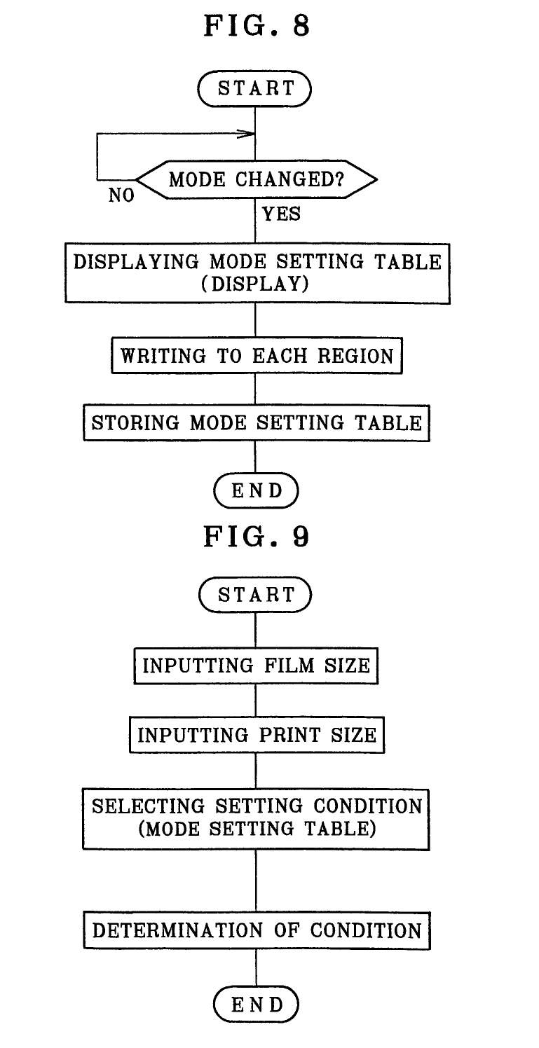

Incidentally, the mode setting tables 107 and 108 are described as an example. The setting conditions I, II and III written in the respective regions 107a, 108a and 108b are properly selectable and changeable. In this case, the mode setting table is indicated on the display, and one of the setting conditions I, II and III is written in the region designated by the operation system 18, along a flowchart shown in FIG. 8.

As the high-image-quality setting condition I written in the respective regions, there is the foregoing high-image-quality mode A wherein the high image quality is obtained by increasing the read pixel number in the scanner 12. Besides this, the high image quality may be obtained by using the foregoing high-image-quality modes B, C and D. Further, the high-image-quality modes A to D may be properly combined as the setting conditions.

As the high-speed-processing setting condition II, there is the forgoing high-speed mode A wherein the high-speed processing is obtained by reducing the read pixel number in the scanner 12. Besides this, the high-speed processing may be obtained by using the forgoing high-speed modes B to D. Further, the high-speed modes A to D may be properly combined as the setting condition.

FIG. 9 is a flowchart showing a process sequence of this embodiment. First of all, the film size of the objective film F is read from the film carrier 100. Then, a signal of the film size is sent to the mode setting section 105. Meanwhile, a preset print-size signal is inputted to the mode setting section 105. In the mode setting section 105, the setting condition meeting the size is selected on the basis of the film size and the print size, referring to the mode setting table. For instance, in a case that the high-speed-processing mode is set such as shown in FIG. 7, the setting condition is set on the basis of the high-speed-processing condition when the film is the IX240-type and the print size is the L-size. Thus, in this case, the high image quality is slightly deteriorated and the high-speed processing is prioritized so that the image is efficiently read. Incidentally, even if the film is the IX240-type, the image is read in the default setting condition when the 2L-size and the six-piece size is designated, for example. Under this default setting condition, the condition is set in the intermediate setting condition in which the high image quality and the high-speed processing are evenly prioritized.

In this way, the optimum setting condition is set in accordance with the film size and the print size. Owing to this, it is possible to read the image properly and efficiently.

In the above embodiment, the setting condition is changed in accordance with the film size and the print size. However, in a case that an image reader outputs the image data instead of the print, the setting condition may be changed in accordance with the film size and an image-data size.

In the above embodiment, the area CCD sensor 34 is employed. However, a line CCD sensor may be employed instead of the area CCD sensor. In this case, the image is read by moving at least one of the film and the line CCD sensor in a sub-scanning direction. With respect to a method for improving an SN ratio, it is supposed to change the storage charge amount and to read the image in a state that a sub-scanning speed is lowered.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. An image reader comprising:
image reading means for reading image data from an image original on the basis of an image read condition;
image processing means for executing image processing for said image data on the basis of an image processing condition;
mode setting means provided with operation modes including at least a high-image-quality mode and a high-speed mode, said mode setting means changing the image read condition and the image processing condition, which are individually set to the respective operation modes, in accordance with the operation mode; and
selection means for selecting each of said operation modes on the basis of a size of said image original and an image output size.

2. An image reader according to claim 1, wherein said operation modes includes a normal mode intermediately set between said high-image-quality mode and said high-speed mode.

3. An image reader according to claim 2, wherein said selection means has a table including items of the image-original size and the image output size, and a corresponding setting condition is written in a region of the table designated by said items.

4. An image reader according to claim 3, wherein said selection means includes setting means for writing the setting condition in accordance with designation given by a user.

5. An image reader according to claim 4, wherein said selection means includes input means for inputting the image-original size and the image output size, said selection means automatically selecting the corresponding setting condition on the basis of the image-original size and the image output size, which are inputted by said input means.

6. An image reader according to claim 4, wherein said selection means includes input means for selecting said setting condition in accordance with the designation given by the user.

7. An image reader according to claim 1, wherein under the high-image-quality mode, the image read condition and the image processing condition are set so as to obtain high image quality by changing at least one of setting conditions including a pixel read number, a read output level, a correcting process, image display performed after the correcting process, and an examination performed after the correcting process, and under the high-speed mode, the image read condition and the image processing condition are set so as to execute processing at high speed by changing at least one of the setting conditions including the pixel read number, the read output level, the correcting process, the image display performed after the correcting process, and the examination performed after the correcting process.

8. An image reader according to claim 1, wherein said image original is a photo film and said image reading means is a scanner for reading an image photographed on said photo film.

9. An image reader according to claim 8, wherein said image reading means performs pre-scanning and main scanning, and the image read condition in the main scanning is determined by the pre-scanning.

10. An image reader according to claim 9, wherein said image processing is executed for pre-scan data obtained by the pre-scanning, said image reader further including:
a pre-scan converter for performing color-reproduction conversion relative to the pre-scan data for which the image processing has been already executed; and
a display for showing the pre-scan data for which the color-reproduction conversion has been already performed by said pre-scan converter.

11. An image reader according to claim 9, wherein said image processing is executed for main-scan data obtained by the main scanning, said image reader further including:
a main-scan converter for performing color-reproduction conversion relative to the main-scan data for which the image processing has been already executed; and
a printer processor for producing a print on the basis of the main-scan data for which the color-reproduction conversion has been already performed by said main-scan converter.

12. An image reader according to claim 11, wherein said printer processor produces the print by scanning a photosensitive material with a light beam modulated in accordance with the main-scan data transferred from said main-scan converter.

13. An image reader according to claim 12, wherein said photosensitive material is a photographic printing paper.

14. An image reader according to claim 13, wherein a color of said light beam is one of red, green and blue, and said photosensitive material is scanned with the three-color light beams in turn.
